(19) United States
(12) Patent Application Publication
(10) Pub. No.: US 2022/0275220 A1
(43) Pub. Date: Sep. 1, 2022

(54) METHOD FOR PREPARING THIN FILM PIEZORESISTIVE MATERIAL, THIN FILM PIEZORESISTIVE MATERIAL, ROBOT AND DEVICE

(71) Applicants: Tsinghua University, Beijing (CN); Tencent Technology (Shenzhen) Company Limited, Shenzhen (CN)

(72) Inventors: Jianshi TANG, Beijing (CN); Zhenxuan ZHAO, Beijing (CN); Yuan DAI, Shenzhen (CN); Zhengyou ZHANG, Shenzhen (CN); Jian YUAN, Beijing (CN); Huaqiang WU, Beijing (CN); He QIAN, Beijing (CN); Bin GAO, Beijing (CN)

(21) Appl. No.: 17/747,911

(22) Filed: May 18, 2022

Related U.S. Application Data
(63) Continuation of application No. PCT/CN2021/080860, filed on Mar. 15, 2021.

(30) Foreign Application Priority Data
Mar. 16, 2020 (CN) 202010181264.7

(51) Int. Cl. C09D 5/24; C09D 7/61; C09D 7/20; C09D 175/04; C09D 163/00; H01C 10/10; H01C 17/00; B25J 9/16

(52) U.S. Cl. CPC C09D 5/24; C09D 7/61; C09D 7/20; C09D 175/04; C09D 163/00; H01C 10/10; H01C 17/00; B25J 9/1694; C08K 2201/001; C08K 2201/011; C08K 3/041

(57) ABSTRACT

Embodiments of this application provide a method for preparing a thin film piezoresistive material, a thin film piezoresistive material, a robot, and a device. The method includes: determining a mass ratio of conductive particles to a cross-linked polymer in preparation of the thin film piezoresistive material, a value range of the mass ratio being 3:97 to 20:80; dispersing the conductive particles and the cross-linked polymer in a solvent according to the mass ratio, to obtain a first dispersion; and curing the first dispersion by using a liquid dropping method within a temperature range of 25° C. to 200° C., to obtain the thin film piezoresistive material. The technical solutions provided by the embodiments of this application provide a method for preparing a thin film piezoresistive material through liquid dropping, thereby effectively controlling the thickness of the piezoresistive material, so that the prepared thin film piezoresistive material has a relatively small thickness.

### CROSS-REFERENCE TO RELATED APPLICATIONS

This application is a continuation application of PCT Patent Application No. PCT/CN2021/080860, entitled “METHOD FOR PREPARING THIN FILM PIEZORESISTIVE MATERIAL, THIN FILM PIEZORESISTIVE MATERIAL, ROBOT AND DEVICE” filed on Mar. 15, 2021, which claims priority to Chinese Patent Application No. 202010181264.7, entitled “METHOD FOR PREPARING THIN FILM PIEZORESISTIVE MATERIAL, THIN FILM PIEZORESISTIVE MATERIAL, ROBOT AND DEVICE” filed with the China National Intellectual Property Administration on Mar. 16, 2020, both of which are incorporated herein by reference in their entirety.

### FIELD OF THE TECHNOLOGY

Embodiments of this application relate to the field of electronic material research technologies, and in particular, to a method for preparing a thin film piezoresistive material, a thin film piezoresistive material, a robot, and a device.

### BACKGROUND OF THE DISCLOSURE

A piezoresistive material is a material with a piezoresistive characteristic, that is, the impedance of the piezoresistive material changes with pressure.

In the related art, with a water-dispersed carbon material and a borohydride as raw materials, and with an open cell sponge as a three-dimensional template, a sponge containing the carbon material or a borohydride compound is obtained through impregnation. After being dried, the sponge is poured or impregnated with different types of macromolecule materials to prepare a three-dimensional mesh compound material. The compound material may be used as a piezoresistive material, and the impedance of the piezoresistive material may change with pressure.

In the foregoing technology, the prepared piezoresistive material is sponge-like and excessively thick, and occupies a relatively large space.

### SUMMARY

The embodiments of this application provide a method for preparing a thin film piezoresistive material, a thin film piezoresistive material, a robot, and a device, which may prepare a thin film piezoresistive material with relatively small thickness. The technical solutions are as follows:

According to one aspect, the embodiments of this application provide a method for preparing a thin film piezoresistive material. The method includes:

determining a mass ratio of conductive particles to a cross-linked polymer in preparation of the thin film piezoresistive material, a value range of the mass ratio being 3:97 to 20:80;

dispersing the conductive particles and the cross-linked polymer in a solvent according to the mass ratio, to obtain a first dispersion; and

curing the first dispersion by using a liquid dropping method within a temperature range of 25° C. to 200° C., to obtain the thin film piezoresistive material.

According to another aspect, the embodiments of this application provide a thin film piezoresistive material, prepared using the foregoing method.

According to further another aspect, the embodiments of this application provide a robot skin, including a thin film piezoresistive material prepared using the foregoing method.

According to still another aspect, the embodiments of this application provide a robot, including a robot skin, the robot skin including a thin film piezoresistive material prepared using the foregoing method.

According to yet another aspect, the embodiments of this application provide an electronic device. The electronic device includes an electronic circuit, and the electronic circuit includes a thin film piezoresistive material. The thin film piezoresistive material is prepared using the foregoing method.

The technical solutions provided in the embodiments of this application may include the following beneficial effects:

This application provides a method for preparing a thin film piezoresistive material through liquid dropping, which includes dispersing conductive particles and a cross-linked polymer in a solvent according to a required mass ratio to obtain a first dispersion, and curing the first dispersion by using a liquid dropping method to obtain the required thin film piezoresistive material, thereby effectively controlling the thickness of the piezoresistive material, so that the prepared thin film piezoresistive material has a relatively small thickness.

It is to be understood that the foregoing general descriptions and the following detailed descriptions are merely exemplary and explanatory, and are not intended to limit this application.

### BRIEF DESCRIPTION OF THE DRAWINGS

To describe the technical solutions in embodiments of this application more clearly, the following briefly describes the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a flowchart of a method for preparing a thin film piezoresistive material according to an embodiment of this application.

FIG. 2 is a flowchart of a method for preparing a thin film piezoresistive material according to another embodiment of this application.

FIG. 3 is a schematic diagram of a thin film piezoresistive material according to an embodiment of this application.

FIG. 4 is a schematic diagram of a relationship between the pressure and thickness of a thin film piezoresistive material and the sensitivity of the thin film piezoresistive material according to an embodiment of this application.

FIG. 5 is a schematic diagram of a relationship between thickness of a thin film piezoresistive material and a piezoresistance variation range according to an embodiment of this application.

FIG. 6 is a schematic diagram of a relationship between an active ingredient concentration in a pre-curing agent and sensitivity as well as a piezoresistive response range according to an embodiment of this application.

FIG. 7 is a schematic diagram of a pressure response/recovery time of a thin film piezoresistive material according to an embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations that are consistent with this application. On the contrary, the implementations are merely examples of methods or products that are described in detail in the appended claims and that are consistent with some aspects of this application.

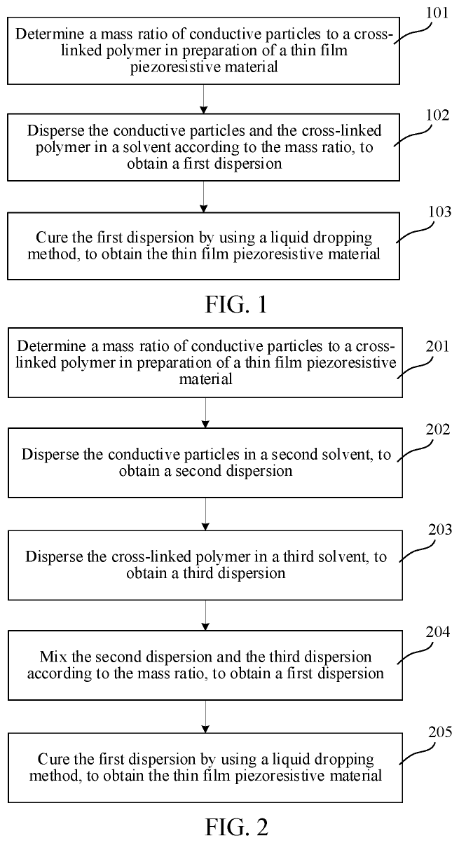

FIG. 1 is a flowchart of a method for preparing a thin film piezoresistive material according to an embodiment of this application. In this embodiment, the method may include the following steps (101 to 103):

Step 101: Determine a mass ratio of conductive particles to a cross-linked polymer in preparation of the thin film piezoresistive material.

In some embodiments, a value range of the mass ratio of the conductive particles to the cross-linked polymer is 3:97 to 20:80. In some embodiments, piezoresistive performance is a degree to which the resistance of a material changes with pressure on the material. A greater change in the resistance of the material with the pressure on the material indicates better piezoresistive performance of the material. On the contrary, a smaller change in the resistance of the material with the pressure on the material indicates worse piezoresistive performance of the material. If the mass ratio of the conductive particles to the cross-linked polymer is less than 3:97, the conductive substance (namely, the conductive particles) in the prepared thin film piezoresistive material is insufficient. As a result, the thin film piezoresistive material has high resistance before and after pressure is applied, has low conductivity (or there is almost no conductivity, and in this case, the thin film piezoresistive material is equivalent to a non-conductor). The thin film piezoresistive material has little or no change in resistance before and after pressure is applied; the piezoresistive performance is poor, which can hardly meet an actual due requirement. If the mass ratio of the conductive particles to the cross-linked polymer is greater than 20:80, the conductive substance (namely, the conductive particles) in the prepared thin film piezoresistive material is excessive. As a result, the thin film piezoresistive material has low resistance before and after pressure is applied, and has excessively high conductivity (which is equivalent to conductivity of a wire). The thin film piezoresistive material has little or no change in resistance before and after the pressure is applied; the piezoresistive performance is poor, which also fails to meet an actual due requirement. Therefore, the mass ratio of the conductive particles to the cross-linked polymer is controlled in the range of 3:97 to 20:80, to ensure that the obtained thin film piezoresistive material has specific piezoresistivity.

In some embodiments, the thin film piezoresistive material includes the conductive particles and the cross-linked polymer. The conductive particles are a particle-like substance with conductivity. The conductive particles may have nanoscale sizes. The maximum size of the conductive particles may be hundreds of nanometers, tens of nanometers, or a few nanometers. The cross-linked polymer, also known as a cross-linked macromolecule, is a polymer with a three-dimensional mesh structure.

The conductive particles may include at least one of the following: multi-walled carbon nanotubes, graphene, and conductive metal nanoparticles. When the conductive particles are the multi-walled carbon nanotubes, a length-diameter ratio (which is a ratio of length to diameter) of the multi-walled carbon nanotubes is greater than 1. In the thin film piezoresistive material, a mass ratio of the multi-walled carbon nanotubes to the thin film piezoresistive material is 3:100 to 20:100 (that is, the mass ratio of the conductive particles to the cross-linked polymer is 3:97 to 20:80). A specific value of the mass ratio of the multi-walled carbon nanotubes to the thin film piezoresistive material is set by a related technical person according to an actual situation. This is not limited in the embodiments of this application. As the length-diameter ratio of the multi-walled carbon nanotubes increases, the finally prepared thin film piezoresistive material has higher sensitivity.

The sensitivity is a degree of change in a response amount resulting from a change in unit concentration or unit amount of a to-be-measured substance in a method. In this application, the sensitivity of the thin film piezoresistive material may be represented by a ratio of a variation in the current of the thin film piezoresistive material to the intensity of pressure on the thin film piezoresistive material, or may be represented by a ratio of a variation in the impedance of the thin film piezoresistive material to the intensity of pressure on the thin film piezoresistive material.

In some embodiments, the cross-linked polymer includes at least one of the following: thermoplastic polyurethane and epoxy.

Step 102: Disperse the conductive particles and the cross-linked polymer in a solvent according to the mass ratio, to obtain a first dispersion.

The dispersion may be a mixed liquid obtained by uniformly dispersing solid particles or a liquid substance in the solvent. The conductive particles and the cross-linked polymer may be uniformly dispersed in the solvent. The solvent may include one or more organic solvents. The mass ratio of the conductive particles to the cross-linked polymer in the first dispersion meets the mass ratio determined in step 101.

Step 103: Cure the first dispersion by using a liquid dropping method, to obtain the thin film piezoresistive material.

In some embodiments, the first dispersion is cured by using the liquid dropping method within a temperature range of 25° C. to 200° C., to obtain the thin film piezoresistive material. If a curing temperature is lower than 25° C., due to the excessively low temperature, the curing speed of the first dispersion is slow, resulting in low curing efficiency. If the curing temperature is higher than 200° C., due to the excessively high temperature, the curing speed of the dispersion in some areas of the first dispersion (such as an edge area) is significantly faster than that in other areas. As a result, the curing speed of the first dispersion is not uniform in different parts, and thus the thin film piezoresistive material is not flat enough or the thickness thereof is not uniform enough. Therefore, the first dispersion is cured within the temperature range of 25° C. to 200° C., which not only can ensure certain curing efficiency, but also avoid a phenomenon that the film piezoresistive material is not flat enough or the thickness thereof is not uniform enough.

The liquid dropping method in this application is a material preparation method of dropping a mixed liquid (such as the first dispersion) on a surface of an object. After an organic solvent in the liquid volatilizes, the remaining solid is a thin film piezoresistive material.

The method of dropping a mixed liquid on a surface of an object may be as follows: taking a certain amount of the mixed liquid by using a titration apparatus (such as a dropper), suspending the drip opening of the titration apparatus vertically above the surface of the object, and then dropping the mixed liquid from the drip opening onto the surface of the object through squeezing or the like.

Based on the above, the technical solutions provided by the embodiments of this application provide a method for preparing a thin film piezoresistive material through liquid dropping, which includes dispersing conductive particles and a cross-linked polymer in a solvent according to a required mass ratio to obtain a first dispersion, and curing the first dispersion by using a liquid dropping method to obtain the required thin film piezoresistive material, thereby effectively controlling the thickness of the piezoresistive material, so that the prepared thin film piezoresistive material has a relatively small thickness.

In the embodiments of this application, because the thickness of the prepared thin film piezoresistive material is relatively small, the sensitivity and responsivity of the thin film piezoresistive material are also improved correspondingly.

FIG. 2 is a flowchart of a method for preparing a thin film piezoresistive material according to another embodiment of this application. In this embodiment, the method may include the following steps (201 to 205):

Step 201: Determine a mass ratio of conductive particles to a cross-linked polymer in preparation of the thin film piezoresistive material.

For the specific content of step 201, reference may be made to the content of step 101 in the embodiment of FIG. 1, and details are not described herein again.

Step 202: Disperse the conductive particles in a second solvent, to obtain a second dispersion.

After the conductive particles are added into the second solvent, the conductive particles are dispersed uniformly in the second solvent, to the second dispersion. When the conductive particles are multi-walled carbon nanotubes, and the second solvent is N-Methyl pyrrolidone, a concentration of the multi-walled carbon nanotubes in the second dispersion is greater than or equal to 0.1% and less than or equal to 10%.

In some embodiments, step 202 may include the following substeps:

1. Add the conductive particles into the second solvent.

2. Disperse the conductive particles in the second solvent by using a dispersion apparatus, to obtain the second dispersion.

Because the dispersion apparatus can improve the dispersion speed and dispersion uniformity of the particles, after the conductive particles are added into the second solvent, the conductive particles may be dispersed by using the dispersion apparatus, thereby conveniently and quickly obtaining the second dispersion with better dispersion uniformity.

The dispersion apparatus includes at least one of the following: an ultrasonic dispersion apparatus and a vacuum dispersion machine.

In some embodiments, when the ultrasonic dispersion apparatus is used for dispersing the conductive particles, a container containing the conductive particles and the second solvent is placed in an ultrasonic receiving area of the ultrasonic dispersion apparatus, so that the conductive particles are dispersed in the second solvent as uniformly as possible. During the process of the dispersing, the ultrasonic dispersion apparatus may be controlled, for a plurality of times (or once), to stop emitting ultrasonic waves, or the container is moved out of the ultrasonic receiving area for a plurality of times (or once). Within a time interval between two ultrasonic dispersions, the conductive particles and the second solvent may be stirred by using a second stirring apparatus to accelerate the dispersion speed of the conductive particles, and prevent the performance of the thin film piezoresistive material from being affected by the excessively high temperature of the conductive particles and the second solvent.

The second stirring apparatus may be a magnetic stirring apparatus, or a mechanical stirring apparatus. This is not limited in the embodiments of this application.

Step 203: Disperse the cross-linked polymer in a third solvent, to obtain a third dispersion.

After the cross-linked polymer is added into the third solvent, the cross-linked polymer is dispersed uniformly in the third solvent, to obtain the third dispersion. When the cross-linked polymer is thermoplastic polyurethane, and the third solvent is an N, N-dimethyl formamide solution, in the third dispersion, a mass ratio of the thermoplastic polyurethane to the N, N-dimethyl formamide solution is 1:2 to 1:50.

In some embodiments, step 203 may include the following substeps:

1. Add the cross-linked polymer into the third solvent.

2. Disperse the cross-linked polymer in the third solvent by using a first stirring apparatus, to obtain the third dispersion.

The stirring apparatus is adopted to stir the third solvent where the cross-linked polymer is added, which may improve the dispersion speed of the cross-linked polymer in the third solvent. In some possible embodiments, the first stirring apparatus may be a magnetic stirring apparatus, or a mechanical stirring apparatus. This is not limited in the embodiments of this application.

Step 204: Mix the second dispersion and the third dispersion according to the mass ratio, to obtain a first dispersion.

According to the required mass ratio of the conductive particles to the cross-linked polymer, the concentration of the conductive particles in the second dispersion, and the concentration of the cross-linked polymer in the third dispersion, a mass ratio of the second dispersion to the third dispersion required for preparing the first dispersion may be calculated. Therefore, according to the mass ratio of the second dispersion to the third dispersion, the second dispersion and the third dispersion are mixed to obtain the first dispersion.

In some embodiments, the concentration of the conductive particles in the second dispersion is 5%, and the concentration of the cross-linked polymer in the third dispersion is 45%. In an example, the required mass ratio of the conductive particles to the cross-linked polymer is 1:9. It can be obtained through calculation that the required mass ratio of the second dispersion to the third dispersion for preparing the first dispersion is 1:1. In another example, the required mass ratio of the conductive particles to the cross-linked polymer is 1:5. It can be obtained through calculation that the required mass ratio of the second dispersion to the third dispersion for preparing the first dispersion is 9:5.

Step 205: Cure the first dispersion by using a liquid dropping method, to obtain the thin film piezoresistive material.

For the description of step 205, reference may be made to the content of step 103 in the embodiment of FIG. 1, and details are not described herein again.

In some embodiments, step 205 may include the following substeps:

1. Mix a first solvent and the first dispersion according to a required first viscosity, to obtain a pre-curing agent of the first viscosity.

2. Determine a first dosage of the pre-curing agent according to a concentration of the conductive particles and a concentration of the cross-linked polymer in the pre-curing agent, and a required size of the thin film piezoresistive material.

3. Take the first dosage of the pre-curing agent.

4. Drop the first dosage of the pre-curing agent on a curing area of a substrate for curing, to obtain the thin film piezoresistive material, a temperature range of the substrate being 25° C. to 200° C.

The curing area is an area where the first dosage of the pre-curing agent is used for curing, and the substrate is an object supporting the thin film piezoresistive material. In some embodiments, the substrate may be an electronic circuit, a metal electrode, a silicon plate, or another object. This is not limited in the embodiments of this application. In some embodiments, in order to prevent the substrate from being burnt out, the temperature of the substrate cannot be excessively high. Therefore, the temperature of the substrate is controlled below 200° C., to ensure the safety of the substrate, thereby reducing material waste.

The first solvent may be an N, N-dimethyl formamide solution. Adding the first solvent can change the viscosity of the first dispersion. The more the first solvent is added, the lower viscosity of the obtained pre-curing agent is. After the first solvent is added into the third dispersion, the first solvent and the first dispersion may be stirred by using a third stirring apparatus, thereby accelerating the mixing speed of the first solvent and the first dispersion, and improving the mixing uniformity. The first dosage of the pre-curing agent may be taken in one time or in several times. The first dosage of the pre-curing agent may be put in a dropper or another titration apparatus, and then is dropped in the curing area for curing. During the curing process, the solvent in the pre-curing agent volatilizes. After the curing is completed, the thin film piezoresistive material made of the conductive particles and the cross-linked polymer can be obtained.

It should be noted that, the first stirring apparatus, the second stirring apparatus, and the third stirring apparatus may be the same apparatus or different apparatuses. Alternatively, two of the first stirring apparatus, the second stirring apparatus, and the third stirring apparatus may be the same apparatus. This is not limited in the embodiments of this application.

In some embodiments, before the dropping the first dosage of the pre-curing agent on a curing area of a substrate for curing, to obtain the thin film piezoresistive material, the method may further include the following steps:

1. Adjust a heating plate until a top surface of the heating plate is parallel to a horizontal surface.

2. Place the substrate on the top surface of the heating plate.

3. Keep a temperature of the heating plate and the substrate in the range of 25° C. to 200° C.

By adjusting the heating plate to be horizontal, on the one hand, the pre-curing agent can be prevented from flowing out of the curing area, and on the other hand, the thickness of the thin film piezoresistive material is ensured to be as uniform as possible. The substrate is placed on the heating plate for heating, so that the substrate is uniformly heated, and the whole pre-curing agent is uniformly cured. The pre-curing agent is cured through heating, which can improve the curing speed of the pre-curing agent.

While the temperature of the heating plate and the substrate are kept in a preset temperature range, on the one hand, a relatively quick curing speed of the pre-curing agent can be ensured, and on the other hand, the substrate can be prevented from being burnt out. The preset temperature range may be 25° C. to 200° C., such as 70° C. to 90° C., or 60° C. to 80° C. The preset temperature range may be specifically set by a related technical person according to an actual situation. This is not limited in the embodiments of this application.

Based on the above, in the technical solutions provided by the embodiments of this application, a first solvent is added into a first dispersion to obtain a pre-curing agent with a relatively small viscosity. Therefore, the pre-curing agent can be conveniently dropped smoothly from the titration apparatus, thereby saving the time for preparing the thin film piezoresistive material.

In the embodiments of this application, because the conductive particles have a relatively good dispersion effect in the second solvent, and the cross-linked polymer has a relatively good dispersion effect in the third solvent, the conductive particles are first dispersed in the second solvent to obtain the second dispersion, and the cross-linked polymer is dispersed in the third solvent to obtain the third dispersion. Then the second dispersion and the third dispersion are mixed to obtain the first dispersion. Compared with dispersing the conductive particles and the cross-linked polymer in the same solvent simultaneously, the conductive particles or the cross-linked polymer does not agglomerate easily in the first dispersion, thereby improving the dispersion uniformity and stability of the conductive particles and the cross-linked polymer in the first dispersion.

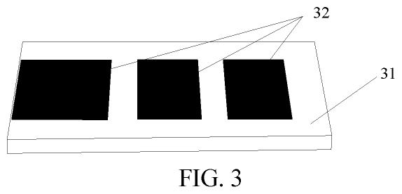

FIG. 3 is a schematic diagram of a thin film piezoresistive material according to an embodiment of this application. As shown in FIG. 3, by using the foregoing method for preparing a thin film piezoresistive material, a thin film piezoresistive material 32 may be obtained on the substrate 31 through curing. Characteristics of the thin film piezoresistive material provided by the embodiments of this application are described below by using an example in which the conductive particles used for preparing the thin film piezoresistive material are multi-walled carbon nanotubes, the cross-linked polymer is thermoplastic polyurethane, the first solvent and the third solvent are both N, N-dimethyl formamide solutions, and the second solvent is N-Methyl pyrrolidone.

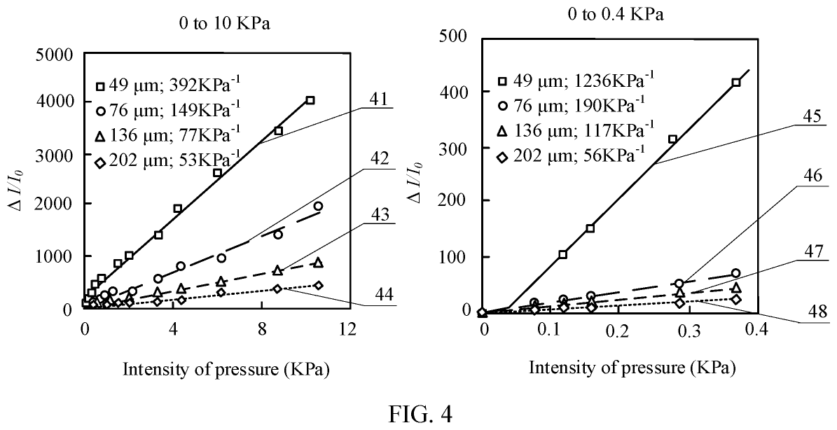

When other conditions are same, the sensitivity of the thin film piezoresistive material under low intensity of pressure is greater than that under high intensity of pressure. When other conditions are same, the smaller the thickness of the thin film piezoresistive material is, the greater the sensitivity is. FIG. 4 is a schematic diagram of a relationship between the pressure and thickness of a thin film piezoresistive material and the sensitivity of the thin film piezoresistive material according to an embodiment of this application. In FIG. 4, the mass percentage of the multi-walled carbon nanotubes in the thin film piezoresistive material is 11.8%. As shown in FIG. 4, the sensitivity of the thin film piezoresistive material with a thickness of 49 μm in an area with an intensity of pressure of 0 to 10 KPa is 392 KPa⁻¹. By comparing a line 41 and a line 45, a line 42 and a line 46, a line 43 and a line 47, and a line 44 and a line 48 respectively, it may be learned that, for the thin film piezoresistive material having the same thickness, sensitivity in an area with an intensity of pressure of 0 to 0.4 KPa is higher than that in an area with an intensity of pressure of 0 to 10 KPa. By comparing the line 41, the line 42, the line 43, and the line 44, it may be learned that the thickness of the thin film piezoresistive material corresponding to the line 41<the thickness of the thin film piezoresistive material corresponding to the line 42<the thickness of the thin film piezoresistive material corresponding to the line 43<the thickness of the thin film piezoresistive material corresponding to the line 44. In the area with an intensity of pressure of 0 to 10 KPa, the sensitivity of the thin film piezoresistive material corresponding to the line 41>the sensitivity of the thin film piezoresistive material corresponding to the line 42>the sensitivity of the thin film piezoresistive material corresponding to the line 43>the sensitivity of the thin film piezoresistive material corresponding to the line 44.

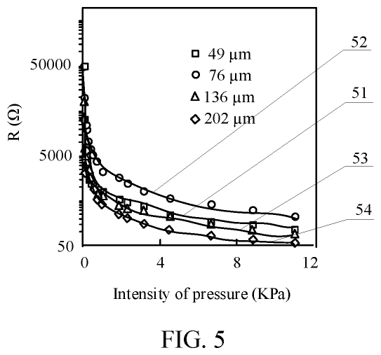

FIG. 5 is a schematic diagram of a relationship between thickness of a thin film piezoresistive material and a piezoresistance variation range according to an embodiment of this application. As shown in FIG. 5, the thickness of the thin film piezoresistive material corresponding to a curve 51<the thickness of the thin film piezoresistive material corresponding to a curve 52<the thickness of the thin film piezoresistive material corresponding to a curve 53<the thickness of the thin film piezoresistive material corresponding to a curve 54, while the relationship of the change range of the piezoresistance is: the change range of the piezoresistance of the thin film piezoresistive material corresponding to the curve 52>the change range of the piezoresistance of the thin film piezoresistive material corresponding to the curve 51>the change range of the piezoresistance of the thin film piezoresistive material corresponding to the curve 53>the change range of the piezoresistance of the thin film piezoresistive material corresponding to the curve 54. It can be seen that a larger thickness of the thin film piezoresistive material does not necessarily correspond to a larger piezoresistance variation range.

Referring to FIG. 4 and FIG. 5, it may be learned that, in the embodiments of this application, a piezoresistive material in the form of a thin film with a micron-level thickness is directly prepared through the liquid dropping method, and the thickness of the piezoresistive material is uniform. The thin film piezoresistive material with a more uniform thickness has piezoresistive performance that is more stable and controllable. The thin film piezoresistive material with a smaller thickness has higher sensitivity. Therefore, the technical solutions provided by the embodiments of this application can improve the piezoresistive performance of the thin film piezoresistive material and the controllability of the piezoresistive performance. Moreover, because the thin film piezoresistive material has a micron-level thickness, the thin film piezoresistive material is also applicable to small-sized precision parts or devices, and has a wide range of applications.

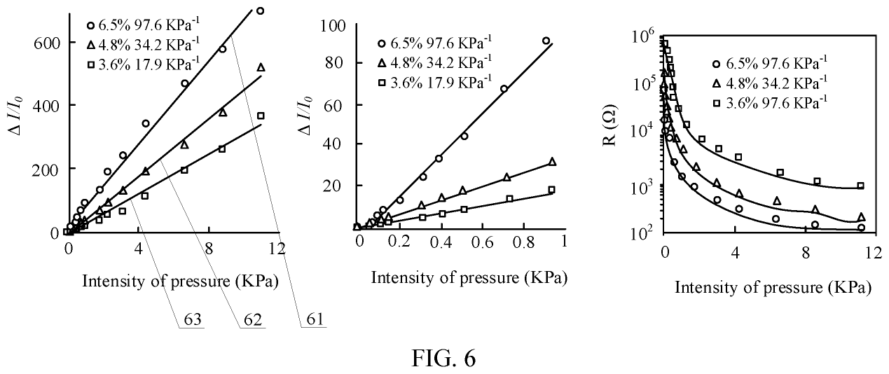

FIG. 6 is a schematic diagram of a relationship between an active ingredient concentration in a pre-curing agent and sensitivity as well as a piezoresistive response range according to an embodiment of this application. The active ingredients include the multi-walled carbon nanotubes and the thermoplastic polyurethane. As shown in FIG. 6, when the masses of the active ingredients are same, and the mass ratios of the multi-walled carbon nanotubes and the thermoplastic polyurethane are also same, a higher concentration of the pre-curing agent indicates higher sensitivity of the prepared thin film piezoresistive material and a smaller piezoresistance variation range. For example, sensitivity corresponding to a curve 61 (the concentration of the pre-curing agent is 6.5%)>sensitivity corresponding to a curve 62 (the concentration of the pre-curing agent is 4.8%)>sensitivity corresponding to a curve 63 (the concentration of the pre-curing agent is 3.6%). The piezoresistance variation range corresponding to the curve 61<the piezoresistance variation range corresponding to the curve 62<the piezoresistance variation range corresponding to the curve 63.

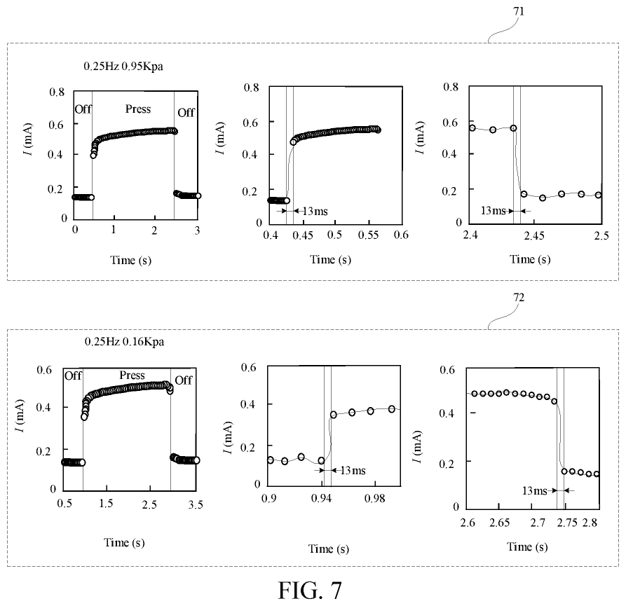

The pressure response time and pressure recovery time of the thin film piezoresistive material are less than 13 ms. FIG. 7 is a schematic diagram of a pressure response/recovery time of a thin film piezoresistive material according to an embodiment of this application. As shown in FIG. 7, a block diagram 71 shows that when an intensity of pressure of 0.95 KPa is applied to the thin film piezoresistive material at a frequency of 0.25 Hz, the pressure response time and pressure recovery time of the thin film piezoresistive material are both less than 13 ms. A block diagram 72 shows that when an intensity of pressure of 0.16 KPa is applied to the thin film piezoresistive material at a frequency of 0.25 Hz, the pressure response time and pressure recovery time of the thin film piezoresistive material are both less than 13 ms.

In addition, in the field of artificial intelligence, a typical application scenario is a robot application. Artificial intelligence (AI) is a theory, method, technology, and application system in which a digital computer or a machine controlled by a digital computer is used for simulating, extending, and expanding human intelligence, sensing an environment, acquiring knowledge, and using the knowledge to obtain an optimal result. In other words, the AI is a comprehensive technology of computer science, which attempts to understand essence of intelligence and produces a new intelligent machine that can respond in a manner similar to human intelligence. The AI is to study the design principles and implementation methods of various intelligent machines, to enable the machines to have the functions of perception, reasoning, and decision-making.

The AI technology is a comprehensive discipline, covering a wide range of fields including both a hardware-level technology and a software-level technology. The basic AI technology generally includes a technology such as a sensor, a dedicated AI chip, cloud computing, distributed storage, a big data processing technology, an operation/interaction system, or mechatronics. AI software technologies mainly include several major directions such as a computer vision technology, a speech processing technology, a natural language processing technology, machine learning/deep learning, and a robot technology.

Robot is a common name for an automatically controlled machine. The robot includes all machines that imitate human behavior or thought and imitate other creatures (such as a robot dog and a robot cat). In the modern industry, a robot may be a man-made mechanical apparatus that can automatically perform a task to replace or assist in work performed by human beings.

The embodiments of this application further provide a robot. The robot may include components such as an actuator, a driving apparatus, a detection apparatus, a control system, and complex machinery. A partial area or an entire area of an outer surface of the robot may be covered with a material that imitates skin of a human being or an animal, which is referred to as robot skin.

In some embodiments, the robot skin is made of a thin film piezoresistive material, has a pressure sensing function, and is a component of the detection apparatus of the robot. When pressure is applied to the robot skin, the impedance of a compressed portion of the robot skin changes with the intensity of the pressure, and magnitude of the current in the robot skin also changes, thereby generating a current signal. The control apparatus of the robot may obtain the current signal, and generate a corresponding control instruction according to the current signal, thereby controlling an action or other reactions of the robot.

In an example, a head portion of the robot is covered with the robot skin made of the thin film piezoresistive material. When the robot moves, the robot skin in the area in the front of the head portion of the robot generates a current signal due to pressure, indicating that there is an obstacle in front of the robot. The control apparatus of the robot may control, according to the current signal, the robot to retreat, thereby avoiding the obstacle.

In another example, the robot is a table tennis sparring robot that can imitate a real person to play a table tennis game. An end portion of a robotic arm of the table tennis sparring robot is used for hitting a ball, and the end portion of the robotic arm may be covered with the robot skin made of the thin film piezoresistive material. When the end portion of the robotic arm touches a ball flying from an opposite side, movement parameters of the ball (such as speed, speed direction, and kinetic energy) may be determined according to a piezoresistance change of the robot skin, thereby controlling the magnitude, direction and time of a force applied by the robot to the ball when the robot hits the ball back.

The embodiments of this application further provide an electronic device. The electronic device includes an electronic circuit and a thin film piezoresistive material attached to the electronic circuit. The thin film piezoresistive material is prepared using the foregoing method.

The electronic device is a device that includes electronic components such as an integrated circuit, a transistor, and an electron tube, and functions based on the technology of technologies. The electronic device may include an electronic computer, a smartphone, a tablet computer, a wearable device, a robot, a numerical control or remote control system, or the like. The electronic circuit is a circuit that includes an electronic device and a related electrical component. The electronic circuit includes an amplifying circuit, an oscillation circuit, a rectifier circuit, a detection circuit, a modulation circuit, a frequency conversion circuit, a waveform conversion circuit, or the like. The electronic circuit further includes various control circuits. In a specific electronic device, the electronic circuit may be a mainboard of the electronic device or another integrated circuit board.

It is to be understood that “plurality of” mentioned in the specification means two or more. A person skilled in the art can easily figure out another implementation solution of this application after considering the specification and practicing this application that is disclosed herein. This application is intended to cover any variations, uses, or adaptive changes of this application following the general principles of this application, and includes well-known knowledge and conventional technical means in the art and undisclosed in this application. The specification and the embodiments are considered as merely exemplary, and the scope and spirit of this application are pointed out in the following claims.

It is to be understood that this application is not limited to the precise structures described above and shown in the accompanying drawings, and various modifications and changes can be made without departing from the scope of this application. The scope of the present application is subject only to the appended claims.

What is claimed is:

1. A method for preparing a thin film piezoresistive material, comprising:
determining a mass ratio of conductive particles to a cross-linked polymer in preparation of the thin film piezoresistive material, a value range of the mass ratio being 3:97 to 20:80;
dispersing the conductive particles and the cross-linked polymer in a solvent according to the mass ratio, to obtain a first dispersion; and
curing the first dispersion by using a liquid dropping method within a temperature range of 25° C. to 200° C., to obtain the thin film piezoresistive material.

2. The method according to claim 1, wherein the curing the first dispersion by using a liquid dropping method within a temperature range of 25° C. to 200° C., to obtain the thin film piezoresistive material comprises:
mixing a first solvent and the first dispersion according to a required first viscosity, to obtain a pre-curing agent of the first viscosity;
determining a first dosage of the pre-curing agent according to a concentration of the conductive particles and a concentration of the cross-linked polymer in the pre-curing agent, and a required size of the thin film piezoresistive material;
taking the first dosage of the pre-curing agent; and
dropping the first dosage of the pre-curing agent on a curing area of a substrate for curing to obtain the thin film piezoresistive material, a temperature range of the substrate being 25° C. to 200° C.

3. The method according to claim 2, wherein before the dropping the first dosage of the pre-curing agent on a curing area of a substrate for curing to obtain the thin film piezoresistive material, the method further comprises:
adjusting a heating plate until a top surface of the heating plate is parallel to a horizontal surface;
placing the substrate on the top surface of the heating plate; and
keeping a temperature of the heating plate and the substrate in the range of 25° C. to 200° C.

4. The method according to claim 1, wherein the conductive particles comprise at least one of the following: multi-walled carbon nanotubes, graphene, or conductive metal nanoparticles.

5. The method according to claim 1, wherein the dispersing the conductive particles and the cross-linked polymer in a solvent according to the mass ratio, to obtain a first dispersion comprises:
dispersing the conductive particles in a second solvent, to obtain a second dispersion;
dispersing the cross-linked polymer in a third solvent, to obtain a third dispersion; and
mixing the second dispersion and the third dispersion according to the mass ratio, to obtain the first dispersion.

6. The method according to claim 5, wherein the dispersing the conductive particles in a second solvent, to obtain a second dispersion comprises:
adding the conductive particles into the second solvent; and
dispersing the conductive particles in the second solvent by using a dispersion apparatus, to obtain the second dispersion.

7. The method according to claim 6, wherein the dispersion apparatus comprises at least one of the following: an ultrasonic dispersion apparatus and a vacuum dispersion machine.

8. The method according to claim 5, wherein the conductive particles comprise the multi-walled carbon nanotubes, and the second solvent comprises N-Methyl pyrrolidone; and
a concentration of the multi-walled carbon nanotubes in the second dispersion is greater than or equal to 0.1%, and less than or equal to 10%.

9. The method according to claim 5, wherein the dispersing the cross-linked polymer in a third solvent, to obtain a third dispersion comprises:
adding the cross-linked polymer into the third solvent; and
dispersing the cross-linked polymer in the third solvent by using a first stirring apparatus, to obtain the third dispersion.

10. The method according to claim 5, wherein the cross-linked polymer comprises thermoplastic polyurethane, and the third solvent comprises an N, N-dimethyl formamide solution; and
in the third dispersion, a mass ratio of the thermoplastic polyurethane to the N, N-dimethyl formamide solution is 1:2 to 1:50.

11. The method according to claim 1, wherein the cross-linked polymer comprises at least one of the following: thermoplastic polyurethane and epoxy.

12. A thin film piezoresistive material, prepared using the method according to claim 1.

13. A robot skin, comprising a thin film piezoresistive material prepared using the method according to claim 1.

14. A robot, comprising a robot skin, the robot skin comprising a thin film piezoresistive material prepared using the method according to claim 1.

15. An electronic device, comprising an electronic circuit, the electronic circuit comprising a thin film piezoresistive material prepared using the method according to claim 1.
